(19) United States
(12) Patent Application Publication
(10) Pub. No.: US 2014/0207475 A1
(43) Pub. Date: Jul. 24, 2014

(54) METHODS AND APPARATUS FOR ORDERS FOLLOW-UP

(71) Applicant: ATHENAHEALTH, INC., Watertown, MA (US)

(72) Inventors: Chip W. Ach, Sudbury, MA (US); Edward J. Magner, Melrose, MA (US); Vakmiki Rao, Cambridge, MA (US); Libby C. Webb, Somerville, MA (US)

(73) Assignee: athenahealth, Inc., Watertown, MA (US)

(21) Appl. No.: 13/746,544

(22) Filed: Jan. 22, 2013

(51) Int. Cl. G06F 19/00

(52) U.S. Cl. CPC G06F 19/34
USPC 705/2

(57) ABSTRACT

Methods and apparatus for using a practice management system to track patient compliance with orders issued to a patient by a medical provider. The method comprises determining whether the patient has filled the orders and sending, in response to determining that the patient has not filled the orders, a notification to the patient, wherein the notification includes information instructing the patient to access a user interface to retrieve information about the orders. The method further comprises receiving input via the user interface, wherein the input indicates a status related to filling the orders and updating the practice management system based on the input received via the user interface, wherein the updating is performed in response to receiving the input via the user interface.

### BACKGROUND

Medical services related to a patient visit to a medical practice may not always be performed during the patient visit. For example, a medical practice may not have resources for performing certain procedures such as medical imaging or laboratory studies, and a physician may issue orders to patients instructing them to have such procedures performed at a different facility that provides these services. When a patient leaves a medical practice, staff at the medical practice may give the patient one or more forms detailing the physician orders describing the procedure(s) to be performed. The patient then takes these form(s) to a service provider's facility (e.g., imaging center, laboratory, pharmacy) where the orders are filled.

To facilitate the storage and management of healthcare information, some medical practices contract with a third-party provider of a practice management system. Information related to patient visits, lab results, and current medications may be stored by the practice management system, and this information may be made available to physicians or other staff at a medical practice electronically through a network-based system to facilitate patient care. Information related to physician orders may also be stored by the practice management system as a part of, or in connection with, a patient's electronic medical record (EMR).

### SUMMARY

The inventors have recognized and appreciated that orders issued by healthcare professionals often go unfilled for a number of reasons and that the status of these orders is often ignored or not tracked. By tracking the status of outstanding orders, patient compliance with such orders may be improved and medical practices may be able to better “close the loop” on orders issued by healthcare providers. For example, after it is determined that the orders have been completed, staff at a medical practice may match corresponding results with the issued orders stored by the practice management system. Alternatively, information indicating the patient's intent not to fill the orders may be received and this information may also be used to close the loop on outstanding orders.

Some embodiments are directed to a method of using a practice management system to track patient compliance with orders issued to a patient by a medical provider. The method comprises determining, with at least one processor, whether the patient has filled the orders; sending, in response to determining that the patient has not filled the orders, a notification to the patient, wherein the notification includes information instructing the patient to access a user interface to retrieve information about the orders; receiving input via the user interface, wherein the input indicates a status related to filling the orders; and updating the practice management system based on the input received via the user interface, wherein the updating is performed in response to receiving the input via the user interface.

Some embodiments are directed to a computer-readable storage medium encoded with a plurality of instructions that, when executed by a computer, perform a method. The method comprises determining, based on information stored by a practice management system, whether a patient has filled orders issued to the patient by a medical provider; sending, in response to determining that the patient has not filled the orders, a notification to the patient, wherein the notification includes information instructing the patient to access a user interface to retrieve information about the orders; receiving input via the user interface, wherein the input indicates a status related to filling the orders; and updating the practice management system based on the input received via the user interface, wherein the updating is performed in response to receiving the input via the user interface.

Some embodiments are directed to a practice management system configured to track patient compliance with orders issued to a patient by a medical provider. The practice management system comprises at least one storage medium configured to store information related to the orders; and at least one processor programmed to: determine based, at least in part, on the stored information related to the orders, whether a patient has filled orders; send, in response to determining that the patient has not filled the orders, a notification to the patient, wherein the notification includes information instructing the patient to access a user interface to retrieve information about the orders; receive input via the user interface, wherein the input indicates a status related to filling the orders; and update the stored information related to the orders based on the input received via the user interface, wherein the updating is performed in response to receiving the input via the user interface.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic of an illustrative practice management system which may be used to implement some embodiments of the invention;

FIG. 2 is an exemplary process for tracking a status of orders issued by a healthcare provider in accordance with some embodiments of the invention;

FIG. 3 is a portion of an illustrative user interface for identifying outstanding orders stored by a practice management system in accordance with some embodiments of the invention;

FIG. 4 is a portion of an illustrative user interface for updating a status of orders stored by a practice management system in accordance with some embodiments of the invention;

FIG. 5 is an illustrative notification that may be sent to a patient regarding outstanding orders stored by a practice management system in accordance with some embodiments of the invention;

FIG. 6 is a portion of an illustrative user interface for a web-based portal configured to inform a patient about outstanding orders stored by a practice management system in accordance with some embodiments of the invention;

FIG. 7 is a portion of an illustrative user interface for a web-based portal configured to enable a user to select an input option related to outstanding orders in accordance with some embodiments of the invention;

FIG. 8 is a portion of an illustrative user interface for a web-based portal configured to enable a user to provide additional input regarding a selected option associated with outstanding orders in accordance with some embodiments of the invention;

FIG. 9 is a portion of an illustrative user interface for a web-based portal for displaying a summary of reminder messages for the patient related to outstanding orders in accordance with some embodiments of the invention; and

FIG. 10 is an illustrative computer system on which some embodiments of the invention may be employed.

### DETAILED DESCRIPTION

The present disclosure generally relates to inventive methods and apparatus for managing information related to provider orders in a practice management system, and more specifically relates to automatically tracking patient compliance with provider orders. By tracking information related to provider orders (also called “orders” herein) and identifying which patients have not yet filled orders, a medical practice may be able improve patient compliance without having to devote additional human resources to follow-up with patients directly. Any suitable type of orders may be used in accordance with the techniques described herein including, but not limited to, imaging orders, consult orders, procedure orders, surgery orders, hearing or vision screening orders, laboratory orders, prescriptions, patient information orders, vaccine orders, and durable medical equipment orders.

Occasionally, patients choose not to fill orders prescribed by a healthcare provider for a variety of reasons including, but not limited to, not wanting to have a procedure and forgetting about filling the orders. However, tracking which patients fill their orders and which do not is often infeasible with conventional systems that rely on paper-based orders forms. Consequently, medical practices typically do not track or follow-up on unfilled orders. The inventors have recognized and appreciated that patient compliance with orders may be improved by using a practice management system to track the status of orders issued by a physician at a medical practice and sending an automated communication to patients associated with orders that have not yet been filled. To this end, the techniques described herein are directed to an automated system for tracking a status of orders issued by providers at a medical practice and sending automated communications to patients associated with outstanding orders to request that the patients provide the medical practice with information about the status of the orders.

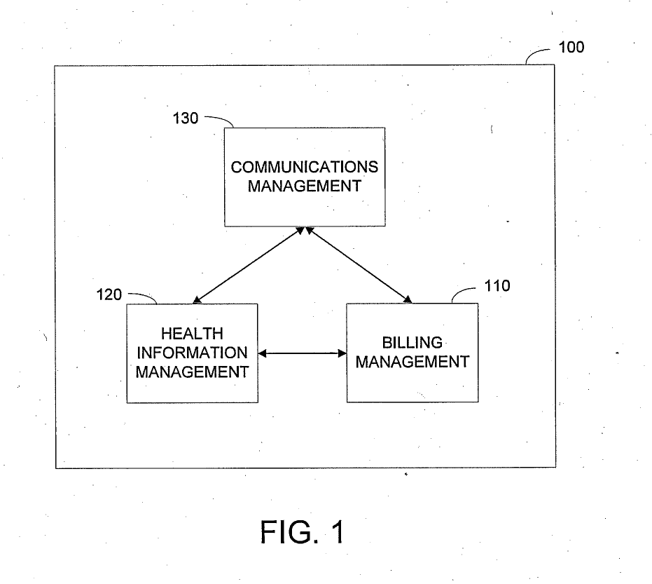

A block diagram of an illustrative practice management system that may be used in accordance with the techniques described herein is shown in FIG. 1. Practice management system 100 may be a networked system that includes a plurality of components configured to perform tasks related to specific functions within the practice management system to facilitate the management of various aspects of medical practices including, billing, managing health information, and communications with patients.

Exemplary practice management system 100 includes health information management component 120, which is configured to store electronic health information for patients at medical practices including, but not limited to, electronic medical records, lab results, imaging results, and orders prescribed by physicians at the medical practice. Health information management component 120 may include one or more processors programmed to manage the electronic health information stored thereon, as discussed in more detail below.

Practice management system 100 may also include billing management component 110, which is configured to facilitate the collection, submission, and tracking of claims filed by the medical practice to a plurality of payers (including patients) to ensure that the medical practice is properly compensated for medical services rendered to patients treated at the medical practice.

Exemplary practice management system 100 may also include communications management component 130, which interacts with health information management component 120 and billing management component 110 to facilitate interactions with patients on behalf of the medical practice using one or more communications channels including, but not limited to, a short messaging service (SMS) communication channel, a web-based communication channel, and phone-based communication channel, a wireless communication channel, and an e-mail based communication channel. In some embodiments, communications management component 130 may include a web-based portal implemented as a portion of a web application, with which patients may interact to perform a plurality of actions associated with services at a medical practice including, but not limited to, providing information about outstanding orders issued by a physician at the medical practice.

Although exemplary practice management system 100 is only shown as having three components, it should be appreciated that practice management systems for use with the techniques described herein may include any number of components (including less than three components) that interact in any suitable way. Furthermore, some or all of the components in practice management system 100 may interact by sharing data, triggering actions to be performed by other components, prevent actions from being performed by other components, storing data on behalf of other components, and/or interacting in any other suitable way. For example, in some embodiments, healthcare information management component 120 may store information related to orders issued to a patient by a physician at a medical practice, and in response to determining that a particular amount of time has passed since the orders were issued, healthcare information management component 120 may interact with communications management component 130 to send an automated message to the patient requesting information about the status of the orders. Other interactions between components of a practice management system are also possible and the techniques described herein are not limited by the manner in which components of a practice management system interact.

In some embodiments, a healthcare information management component of a practice management system may be configured to store information describing orders issued to one or more patients of a medical practice. The practice management system may associate an alarm with at least one of the orders stored by the healthcare information management component. The alarm may be set based, at least in part, on an amount of time after which further action related to the associated orders should be performed. In some embodiments, alarms having different attributes (e.g., different durations) may be associated with orders of different types. For example, staff at a medical practice may specify that all orders for laboratory procedures should be associated with an alarm indicating a follow-up time of one month, whereas all medical resonance imaging (MRI) procedures should be associated with an alarm indicating a follow-up time of two weeks. The practice management system may keep track of the alarms, and provide an indication of the alarm to one or more staff at the medical practice in response to determining that the amount of time associated with the alarm has passed, which is also referred to herein as the alarm “firing.” For example, in some embodiments, after a specified amount of time associated with an alarm has elapsed, an indication of the alarm firing may be indicated on a portion of a user interface displayed to one or more staff at the medical practice. The staff at the medical practice, having been alerted to the outstanding orders, may perform one or more actions to determine if further action associated with the alarm is warranted. In some embodiments, after an amount of time associated with the alarm has passed, a communications component of the practice management system may automatically send one or more communications to a user (e.g., a patient) of the practice management system, as discussed in more detail below.

An alarm may be associated with orders stored by the practice management system in any suitable way including, but not limited to, staff at a medical practice interacting with a user interface provided by the practice management system to associate the alarm with the orders. In some embodiments, all orders stored by the practice management system may be associated with an alarm. However, it should be appreciated that the number of orders associated with an alarm in the practice management system does not limit implementations incorporating one or more of the techniques described herein.

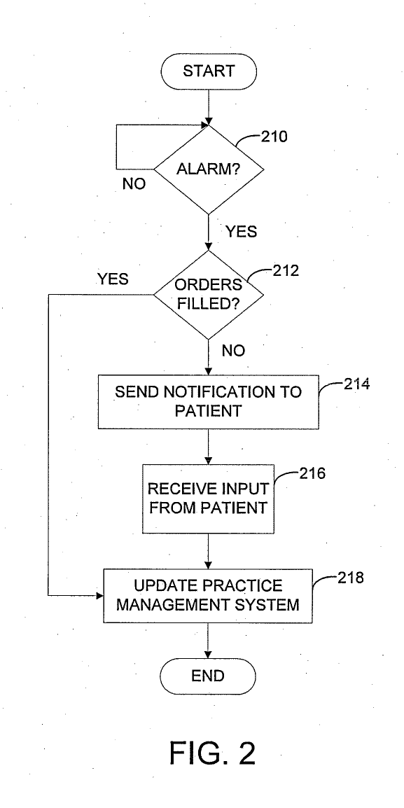

FIG. 2 shows an illustrative process for tracking orders stored by the practice management system in accordance with the techniques described herein. In act 210, one or more processors associated with the practice management system determines whether an alarm associated with orders stored by the practice management system has fired. As discussed above, one or more of the orders stored by the practice management system may be associated with an alarm that specifies an amount of time to pass (e.g., one month) prior to the alarm firing. If it is determined in act 210 that no alarms associated with the medical practice have fired, the process continues to monitor for alarms at a desired interval. In some embodiments, checking for alarms that have fired may be a continuous process such that alarms that fire may be detected in real-time. Alternatively, the practice management system may periodically and/or in response to a user input check for alarms that have fired for a medical practice, and the techniques described herein are not limited based on how frequently the practice management system determines whether one or more alarms have fired.

If it is determined in act 210 that an alarm has fired, the process proceeds to act 212, where it is determined whether the orders associated with the alarm have been filled. If it is determined in act 212 that the orders associated with the alarm have been filled, the process proceeds to act 218 where the practice management system is updated to reflect the status of the orders as being filled. A determination of whether the orders have been filled may be made in any suitable way. For example, when results are received from a service provider such as a laboratory, the practice management system may associate the received laboratory results with orders stored by the practice management system to close the loop on the orders. In some embodiments, the matching of received results to orders stored by the practice management system may be performed automatically by the practice management system using, for example, identifying information included in the received results and the stored orders. Examples of the identifying information include, but are not limited to, a unique identifier associated with the orders. The unique identifier may be included on one or more forms provided to a patient when the orders are issued. A service provider may include this unique identifier with the results of the service or procedure performed by the service provider and the unique identifier included in the results may be used to match the results with the corresponding orders stored by the practice management system. Received results may also be matched with stored orders in any other suitable way including, but not limited to, using other information included in the received results and/or stored orders to perform the matching and the techniques described herein are not limited based on how the matching is performed.

If it is determined in act 212 that the orders associated with the alarm have not been filled, the process proceeds to act 214, where a notification is sent to the patient associated with the outstanding orders. In some embodiments, the notification may be sent automatically in response to determining that the orders have not been filled within a time range specified by the alarm. However, in some embodiments, an indication that the orders associated with the alarm have not been filled may be provided to staff at a medical practice prior to sending a notification to the patient. The indication may be provided to staff at the medical practice in any suitable way. For example, as discussed in further detail below, staff at a medical practice may interact with a user interface provided by the practice management system that displays outstanding tasks for the staff at the medical practice to perform. Among these tasks indicated on the user interface may be to follow up on orders associated with alarms that have fired. The medical practice staff may then consider whether sending a notification to the patient is warranted to determine a status of the orders.

After receiving an indication that the orders have not been filled, the staff at the medical practice may instruct the practice management system to send the notification to the patient (e.g., by interacting with the user interface provided by the practice management system, as described above). By notifying staff at the medical practice prior to sending an automated communication to the patient, the medical practice may have more control over providing communications to patients, and may be able to prevent sending notifications to patients of the medical practice in situations where patient input is not needed. For example, staff at a medical practice may have access to information about orders that would circumvent the need to communicate with the patient about the status of the orders. Examples of such information include, but are not limited to, knowledge that particular orders may be delayed by payer approvals, knowledge that certain patients are not likely to fill the orders based, for example, on past patient behavior, and knowledge that a result associated with the orders has already been received by the medical practice.

Sending a notification to a patient associated with orders stored by practice management system may be performed in any suitable way. For example, in practice management systems that include a communications component configured to send automated communications to patients of the medical practice, the communications component may send the notification to the patient based, at least in part, on one or more patient preferences stored by the practice management system. For example, a patient may indicate that their preferred communication method is by email and they prefer to only receive messages after 5 pm. In response to determining that a notification should be sent to the patient, one or more processors associated with the practice management system may access the stored patient preferences and determine that the notification should be sent as an email after 5 pm. Accordingly, patients may be able to have control over how and when they receive automated messages sent on behalf of the practice management system.

As described in more detail below, the notification sent to a patient may include instructions to access a web-based portal to provide input related to orders issued by a physician of a medical practice associated with the practice management system. After the notification is sent to the patient in act 214, the process proceeds to act 216, where input is received from the patient. The input may be received in any suitable way, and the techniques described herein are not limited by the manner in which patients provide input regarding the status of outstanding orders. For example, in response to receiving a notification from a communications component of the practice management system, a patient may access a web-based portal to provide the requested input, as discussed in further detail below. However, in some embodiments, input may be provided by a patient in ways other than through a web-based portal. For example, a patient may call a phone number included in a notification received from the practice management system to provide the requested information related to a status of the orders, or the input may be received in any other suitable way. In response to receiving the input from the patient in act 216, the process proceeds to act 218 where the practice management system is updated based, at least in part, on the input received from the patient.

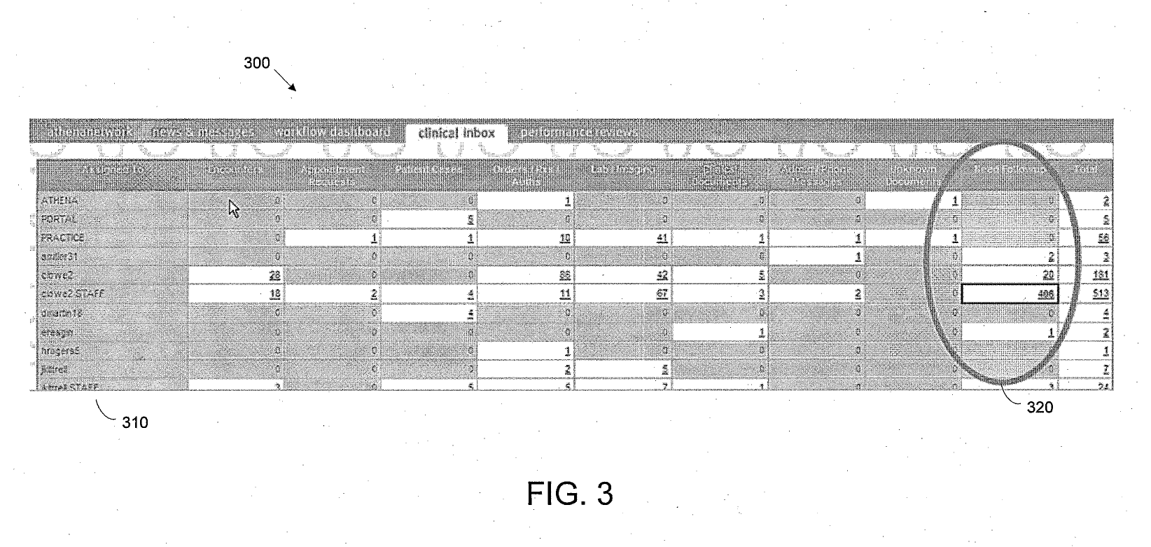

In some embodiments where notifications to patients are not automatically sent in response to determining that an alarm has fired, the practice management system may present a user interface to enable staff at a medical practice to identify orders that have not been filled and should be considered for follow-up with a patient. FIG. 3 shows an illustrative portion of a user interface provided by a practice management system in accordance with the techniques described herein. In particular, FIG. 3 illustrates a portion of a user interface with a dashboard 300 indicating various tasks assigned to staff at a medical practice associated with a practice management system. Exemplary tasks include, but are not limited to, handling appointment requests, processing incoming lab results, answering phone messages received by the medical practice, and initiating follow-up requests for outstanding orders that may not have been filled yet by a patient.

As shown in FIG. 3, dashboard 300 may include a plurality of columns that display tasks assigned to different users at a medical practice. For example, each of a plurality of users at the medical practice may be represented in column 310, and tasks assigned to each of these users may be represented in other columns of dashboard 300. In particular, column 320 may indicate a number of orders stored by the practice management system that may require follow up by staff at the medical practice. The practice management system may assign orders that need follow-up to users of the medical practice in any suitable manner. For example, as shown in column 320 of FIG. 3, some of the individual users have been assigned the task to investigate whether particular orders need follow-up, whereas other orders that may need follow-up are assigned to a general user denoted as “staff” at the medical practice.

Upon determining that there are orders that may need follow-up, a user may interact with the dashboard user interface to select stored orders to determine if they require follow-up. A determination of whether stored orders need follow-up may be made in any suitable manner and the techniques described herein are not limited based on how such a determination is made. For example, users at a medical practice may investigate other information stored by the practice management system including, but not limited to, information received from service providers including laboratories, pharmacies, and imaging facilities, to determine if the orders need follow-up. Users at a medical practice may also be aware of other factors that may be the cause of a delay in filling the orders, such as knowledge that particular service providers are slow in providing the results of procedures performed by the service provider. Any other suitable information may also be used to determine which orders need follow-up.

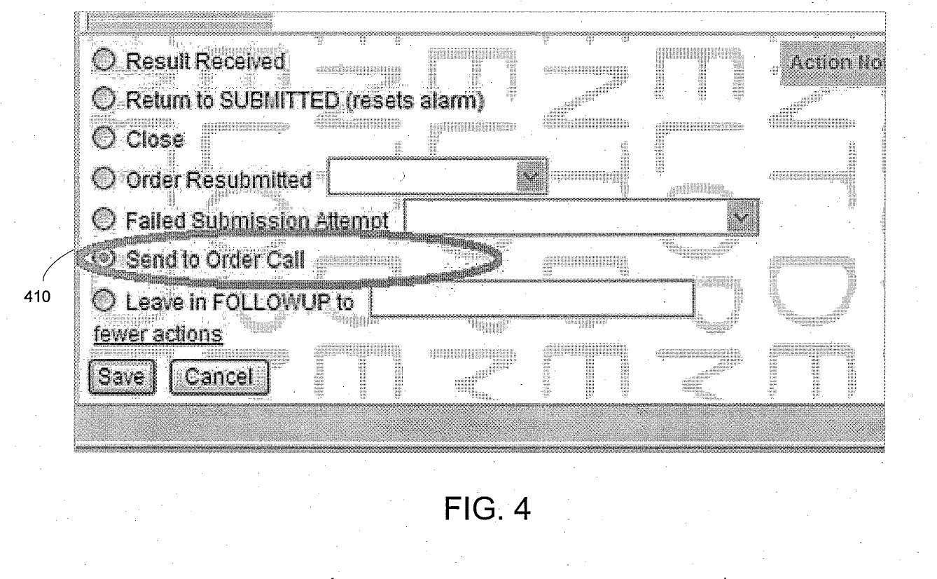

In some embodiments, in response to selecting orders on dashboard 300, the practice management system may update the user interface to display a list of options with which the user may interact to update a status of the orders in the practice management system. FIG. 4 shows an illustrative portion of a user interface for selecting an option to update the status of orders stored by the practice management system in accordance with the techniques described herein. As shown in FIG. 4, the user interface may display a plurality of selectable items corresponding to actions that may be performed regarding the selected orders. For example, these options may include, but are not limited to, indicating that a result corresponding to the orders has been received, resetting an alarm associated with the orders, closing the orders, indicating a date when the orders were resubmitted, indicating a date when submission of the orders failed, leaving the orders in follow-up status for a particular user, and instructing a communications component of the practice management system to send a notification to the patient associated with the orders. In accordance with the techniques described herein, a user may interact with selector 410 to select the option for initiating an automated communication to the patient, and in response, the communications component of the practice management system may send an appropriate notification to the patient, as discussed in more detail below.

Notifications sent to patients on behalf of medical practice in accordance with the techniques described herein may be formatted in any suitable way using any suitable communications medium including, but not limited to, one or more public or private networks. In some embodiments, a communications medium that is selected for transmitting a notification to a patient on behalf of a medical practice may be determined based, at least in part, on patient preference information stored by the practice management system, as discussed above. Additionally, notifications sent by a practice management system may include any suitable content to inform the user to retrieve a health reminder regarding the outstanding orders. In some embodiments, the notification may include instructions to access a health reminder from the medical practice without including protected health information (PHI) associated with the orders. Examples of PHI include, but are not limited to, a patient's medical condition, type of procedure to be performed, or any other information that may typically be included in the patient's medical record. Not including PHI in the notification transmitted between the practice management system and patients of the medical practice across unsecure networks, such as the Internet, may reduce the likelihood that sensitive information would be intercepted by third parties who are not authorized to access information in the notification.

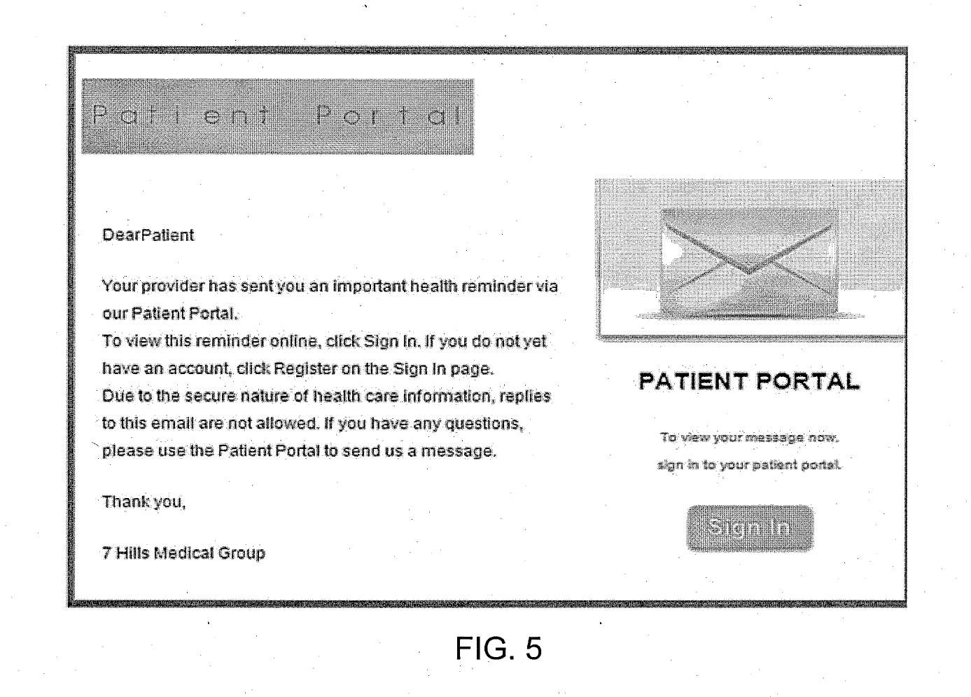

FIG. 5 shows an illustrative notification that may be sent via email to a patient on behalf of the medical practice in accordance with the techniques described herein. The notification may include a message indicating to the user that there is an important health reminder from the medical practice. The notification may also include instructions on how to access the health reminder. For example, the message shown in FIG. 5 prompts the user to access the health reminder by signing in to a web-based portal provided by the practice management system. The notification may also include one or more links to the web-based portal to enable the patient to quickly and conveniently access the health reminder directly from the notification. Although the message in FIG. 5 is a message sent to a patient via e-mail, it should be appreciated that notifications sent to patients in accordance with the techniques described herein may alternatively be sent using other formats and through different communication channels including voice-based messaging, SMS messaging, or any other suitable form of communication channel.

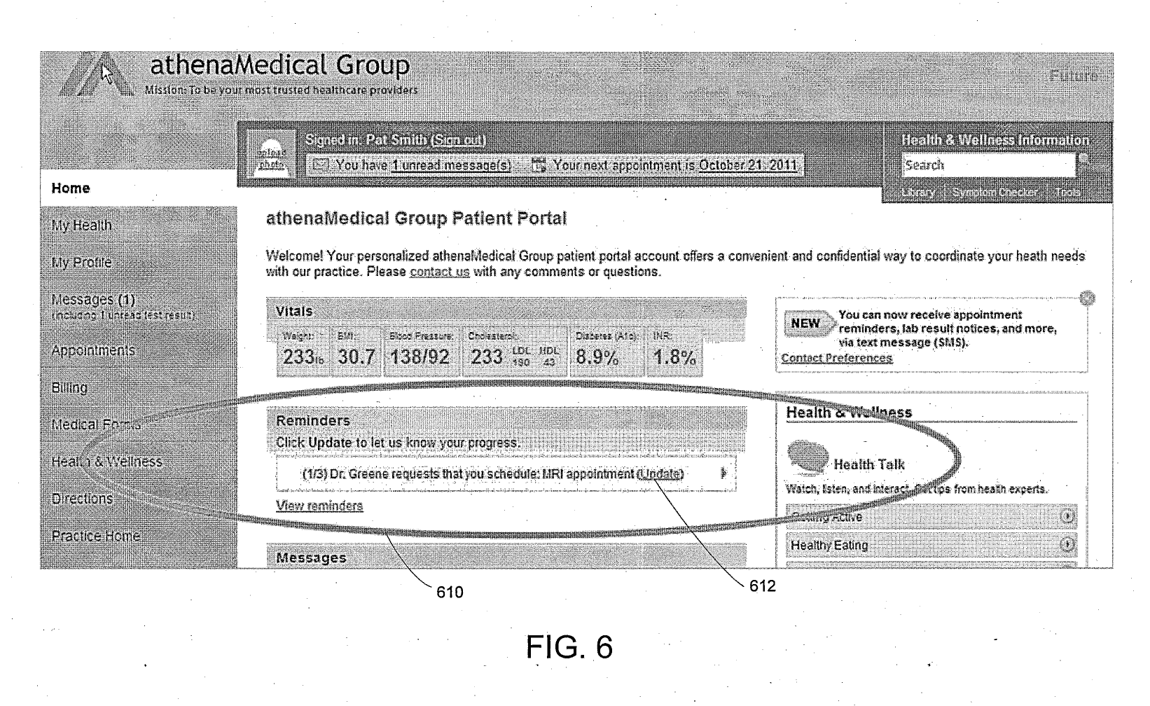

In response to receiving a notification from a medical practice associated with one or more outstanding orders, a patient may access a health reminder from the medical practice by, for example, signing in to a web-based portal provided by the practice management system. FIG. 6 shows an illustrative portion of the user interface for a web-based portal in accordance with the techniques described herein. After the patient has signed in to the web-based portal, the user interface may display a homepage for the patient that includes a plurality of selectable options for performing actions corresponding to a patient's healthcare experience at the medical practice. Included on the homepage may be a reminders section 610 that indicates the patient has at least one health reminder to view for the medical practice. The patient may interact with information in reminders section 610 to provide input related to one or more outstanding orders issued by a physician at the medical practice. For example, as shown in FIG. 6, reminders section 610 includes a reminder message for the patient to schedule an MRI appointment based on orders issued by the physician Dr. Greene. The patient may interact with selector 612 to provide input related to a status of scheduling the MRI appointment.

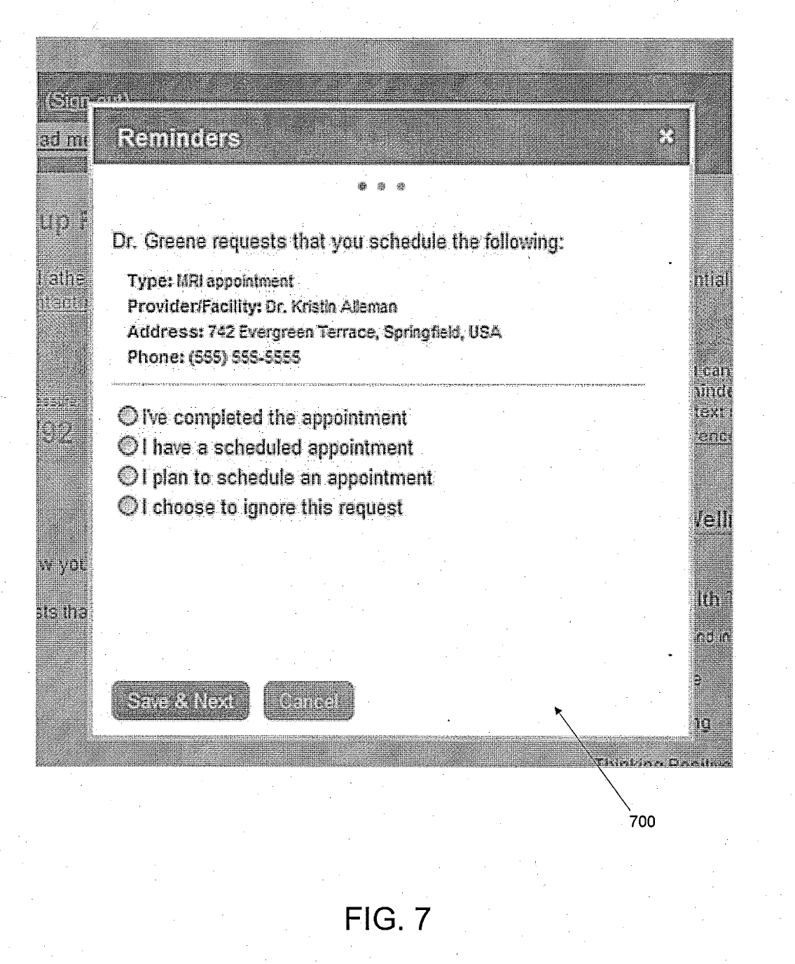

In response to receiving a selection of selector 612, the practice management system may update the user interface to display an input section with which a patient may interact to select from one or more options to provide input associated with the outstanding orders. FIG. 7 shows an illustrative input section 700 as a portion of a user interface that may be presented to a user in response to interacting with selector 612 in accordance with the techniques described herein. Input section 700 includes a plurality of selectable input options for providing input related to a current status of the orders associated with the selected health reminder. In the exemplary input section 700 shown in FIG. 7, four selectable input options are provided. However, it should be appreciated that any number of selectable input options (including one option) may alternatively be used, and the techniques described herein are not limited in this respect. Additionally, the selectable input options shown in input section 700 are illustrated as options with associated radio buttons for selection. However, it should be appreciated that any suitable user interface elements may be used to provide the selectable input options, and the use of radio buttons is merely one example.

Illustrative input section 700 displays four selectable input options associated with an appointment. Each of the four selectable input options, when selected, provides the medical practice with information about the current status of the orders issued by a physician at the medical practice. For example, the patient may indicate that the orders have been filled, that an appointment has been scheduled with the service provider, that an appointment with the service provider has not yet been scheduled but will be scheduled in the future, or that the patient is not planning on scheduling the appointment. It should be appreciated that the input options shown in input section 700 are merely examples and any other options may alternatively be used to prompt users for input related to the status of orders stored by the practice management system in accordance with the techniques described herein. In response to selecting one of the options, the patient may save their input, and choose to perform one or more other actions using the web-based portal. For example, the patient may update the status of one or more other outstanding orders as indicated on the homepage or some other portion of the web-based portal.

In some embodiments, selection of one or more of the selectable input options presented on input section 700 may result in additional input sections being presented on the user interface to enable the user to provide additional information regarding the status of outstanding orders.

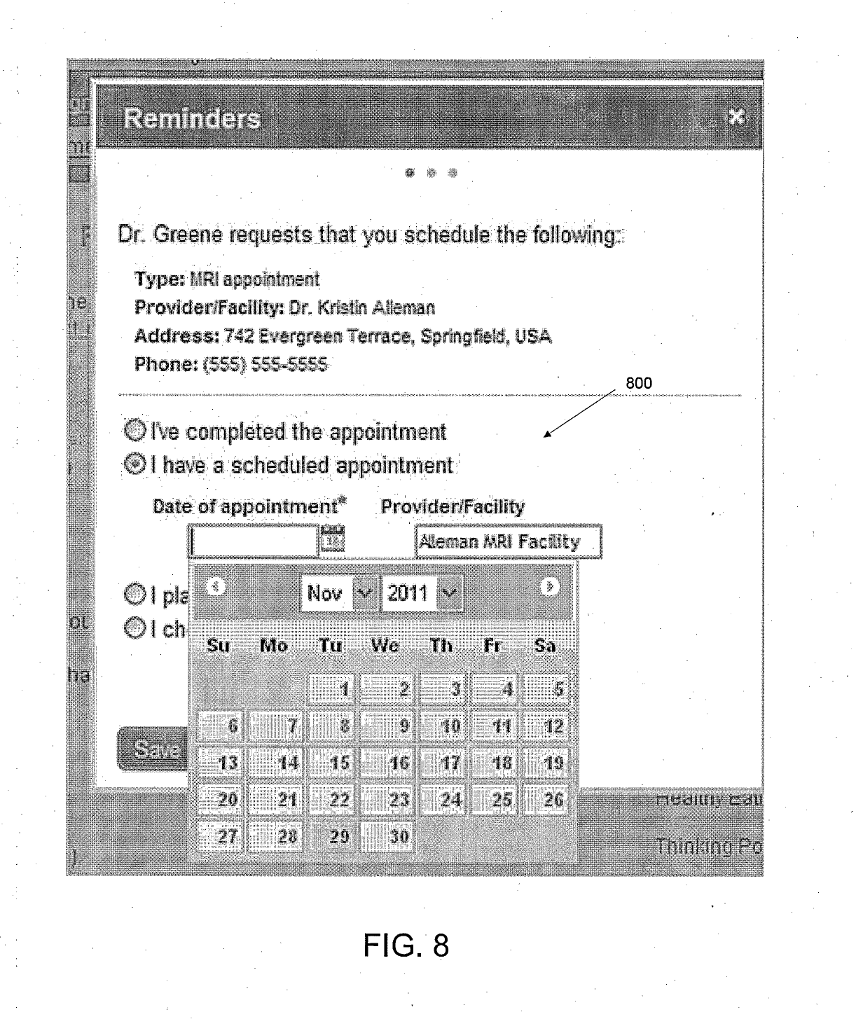

FIG. 8 shows an illustrative additional input section 800 presented in response to selecting an option indicating that the patient has scheduled an appointment in the future associated with the outstanding orders. The patient may interact with additional input section 800 to specify the date of the scheduled appointment and/or information identifying the service provider at which the appointment is scheduled. Providing this information may help the medical practice identify when results for the scheduled procedure should be expected and from which service provider. Additionally, in some embodiments, this information may also be used to schedule one or more additional alarms stored by the practice management system to follow up with the patient if the orders are not filled within a specified amount of time following the scheduled appointment date.

Although additional input section 800 illustrates a date field including a schematic of a calendar for entering the date information, it should be appreciated, that any suitable user interface element may be used to enable the patient to provide this information as input, and the techniques described herein are not limited by the particular type of user interface elements used. Additionally, only two fields for entering additional information are shown in additional input section 800, any number of additional input fields (including a single field) may be included to capture any suitable information associated with the outstanding orders. In some embodiments, the number or type of fields displayed in additional input section 800 may be configurable for one or more of the medical practices associated with the practice management system, such that each medical practice may select which information they would like to capture regarding outstanding orders.

In some embodiments, the web-based portal may include other selectable options associated with performing one or actions related to outstanding orders stored by a practice management system. For example, some embodiments may include a print selector displayed on a user interface provided via a web-based portal and the print selector may enable a patient to print out one or more forms associated with the orders stored by the practice management system.

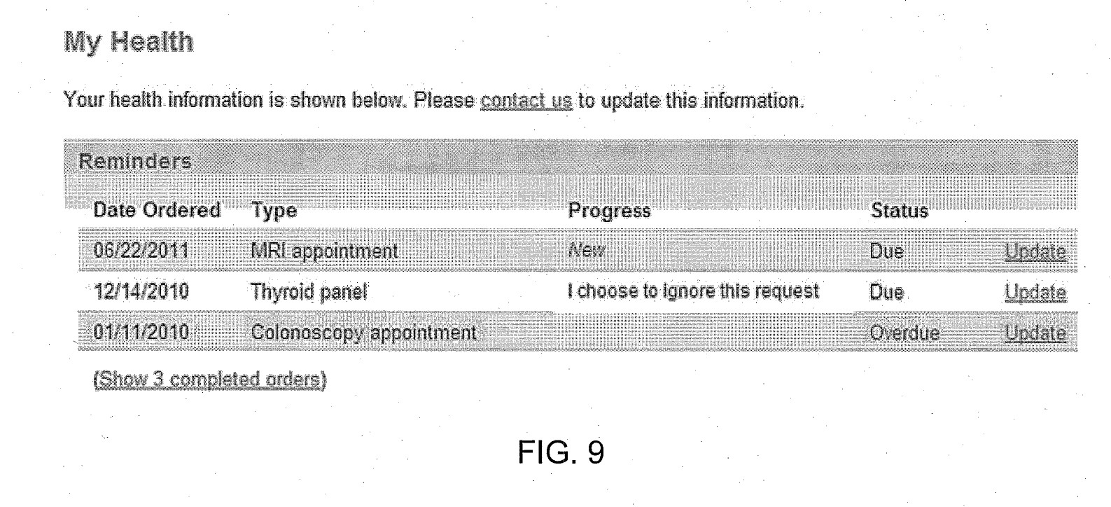

In some embodiments, patients who have signed-in to a web-based portal provided by the practice management system may review a listing of outstanding orders and their associated status as illustrated in FIG. 9. In the example shown in FIG. 9, the patient is associated with three outstanding orders and information about the outstanding orders, including the date when the orders were issued by the physician, is indicated. The patient may interact with one or more of the reminders to update a status associated with one or more of the outstanding orders using one or more of the techniques described herein.

As discussed above, after a patient has provided the input information requested by the medical practice by selecting one of the selectable input options and/or entering any additional information associated with the selected input option, the practice management system may be updated to reflect the information provided by the patient. In some embodiments, the manner in which the practice management system is updated may depend on the particular input option selected by the patient. Updating the practice management system may be performed in any suitable way and the examples for updating a practice management system described below are provided merely for illustrative purposes.

In some embodiments, if the patient indicated that the appointment associated with the outstanding orders has been completed, a status indicator may be associated with the outstanding orders in the practice management system to inform staff at the medical practice that the orders have been completed. For example, a dashboard portion of a user interface, as discussed above, may be updated to reflect that staff at the medical practice should follow up on this order by selecting it from the dashboard. If it has been indicated that the orders have been completed, the staff at the medical practice may search for a corresponding result associated with the outstanding orders and/or call the service provider that rendered the services associated with the outstanding orders to inquire about the status of the result(s).

In some embodiments, if the patient indicated that the appointment associated with the outstanding orders has been scheduled but has not yet taken place, a status indicator may be associated with the outstanding orders to reflect the status of the future appointment. As discussed briefly above, in some embodiments, when a patient indicates the future appointment has been made, the patient may also input additional information indicating the date of the appointment and this additional input may be used to set an alarm. The alarm that may then be used to trigger additional follow-up relating to the outstanding orders, if necessary.

In some embodiments, if the patient indicated that he/she is planning to schedule an appointment but have not yet scheduled one, the practice management system may be updated by setting a new alarm configured to trigger additional follow-up relating to the outstanding orders, if necessary following the firing of this new alarm. The new alarm may have the same duration or a different duration than the original alarm associated with the orders when issued by the physician, and the techniques described herein are not limited by the duration of alarms associated with outstanding orders stored by the practice management system.

In some embodiments, if the patient has indicated that they do not plan to schedule an appointment associated with the outstanding orders, the practice management system may be updated to reflect this intention of the patient. By updating the practice management system in this manner, the medical practice may be able to close the loop on the outstanding orders and staff at the medical practice may choose to follow up with the patient regarding why they selected this option. However, the extent to which staff at a medical practice decides to follow up with a patient after selection of this option does not limit the techniques described herein.

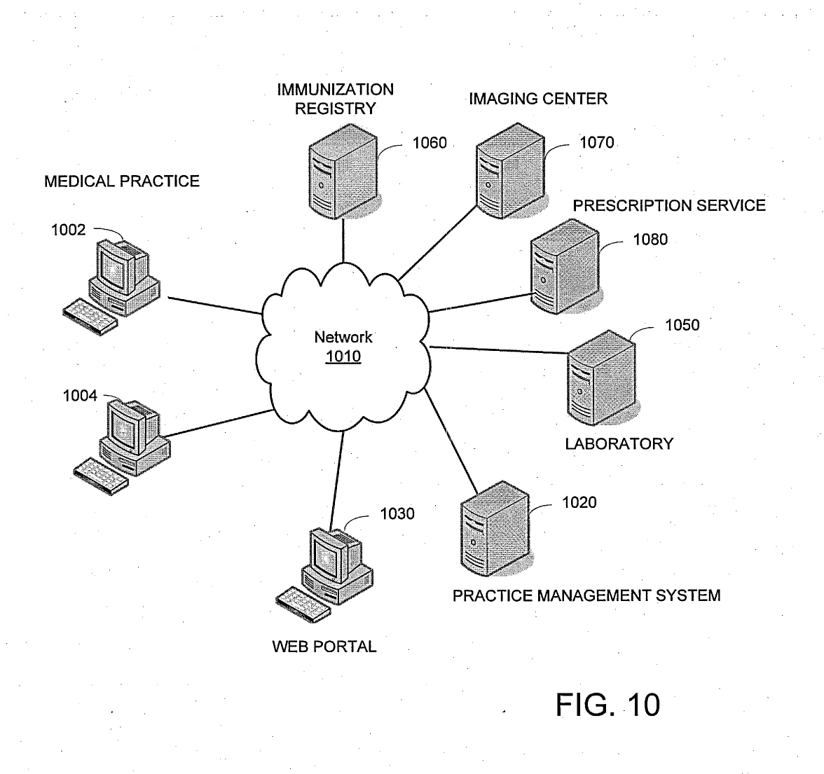

FIG. 10 illustrates an exemplary networked system on which some embodiments of the invention may be employed. Networked computers 1002 and 1004 located at a medical practice, computer 1020 located at a location associated with a practice management system, and computer 1030 configured to display a web-based portal, are shown connected to a network 1010. Additionally, external service providers including laboratory 1050, immunization registry 1060, imaging center 1070, and prescription service 1080, are also shown connected to network 1010. Network 1010 may be any type of local or remote network including, for example, a local area network (LAN) or a wide area network (WAN) such as the Internet. In the example of FIG. 10, two networked computers at a medical practice, one networked computer at a patient location, and four external service providers are shown. However, it should be appreciated that network 1010 may interconnect any number of computers of various types and the networked system of FIG. 10 is provided merely for illustrative purposes. For example, computer 1020 may be connected via network 1010 (or other networks) to a plurality of computers at a plurality of medical practice locations to provide practice management services to each of the connected medical practices. As should be appreciated from the foregoing, embodiments of the invention may be employed in a networked computer system regardless of the type or network size or configuration. Additionally, one or more of the computers in the networked system may be protected from unauthorized access using any suitable security protection devices or processes including, but not limited to, firewalls, data encryption, and password-protected storage.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a tablet computer, a smart phone or any other suitable portable or fixed electronic device.

Also, a computer may have one or more input and output devices. These devices can be used, among other things, to present a user interface, as described above. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form as discussed above in connection with FIG. 10, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer readable storage medium (or multiple computer readable storage media (e.g., a computer memory, a USB drive, a flash memory, a compact disk, a tape, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the techniques described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A method of using a practice management system to track patient compliance with orders issued to a patient by a medical provider, the method comprising:
determining, with at least one processor, whether the patient has filled the orders;
sending, in response to determining that the patient has not filled the orders, a notification to the patient, wherein the notification includes information instructing the patient to access a user interface to retrieve information about the orders;
receiving input via the user interface, wherein the input indicates a status related to filling the orders; and
updating the practice management system based on the input received via the user interface, wherein the updating is performed in response to receiving the input via the user interface.

2. The method of claim 1, further comprising:
storing, by the practice management system, a representation of the orders issued to the patient; and
wherein the updating the practice management system comprises updating the representation of the orders stored by the practice management system.

3. The method of claim 1, further comprising:
associating an alarm with the orders issued to the patient, wherein the alarm specifies an amount of time to wait prior to sending the notification to the patient;
determining whether the amount of time specified by the alarm has passed; and
sending the notification to the patient in response to determining that the amount of time specified by the alarm has passed.

4. The method of claim 1, further comprising:
accessing the practice management system to determine communication preferences for the patient; and
wherein the sending the notification to the patient comprises sending the notification to the patient in accordance with the determined communications preferences for the patient.

5. The method of claim 1, wherein the input received via the user interface includes scheduling information indicating when the patient has scheduled an appointment to fill the orders, and wherein the method further comprises:
associating an alarm with the orders based, at least in part, on the scheduling information.

6. The method of claim 1, wherein the orders are selected from the group consisting of imaging orders, consult orders, procedure orders, surgery orders, hearing or vision screening orders, laboratory orders, prescriptions, patient information orders, vaccine orders, and durable medical equipment orders.

7. The method of claim 1, further comprising:
presenting the user interface as a web-based portal with which the patient may interact to provide the input indicating the status related to filling the orders, wherein the user interface is configured to display a plurality of selectable options that, when selected by the patient, provide the input.

8. The method of claim 1, wherein the input indicating the status related to filling the orders specifies that the orders have been filled by a particular laboratory and/or provider, and wherein the method further comprises:
searching the practice management system to identify clinical results associated with the orders, wherein the clinical results were received by the practice management system from the particular laboratory and/or provider specified in the input indicating the status related to filling the orders.

9. The method of claim 1, wherein sending a notification to the patient comprises sending a short message service (SMS) message, an automated phone call, or an email to the patient.

10. The method of claim 1, further comprising:
providing the user interface as a web-based portal, a telephone service, or a SMS messaging service.

11. A computer-readable storage medium encoded with a plurality of instructions that, when executed by a computer, perform a method comprising:
determining, based on information stored by a practice management system, whether a patient has filled orders issued to the patient by a medical provider;
sending, in response to determining that the patient has not filled the orders, a notification to the patient, wherein the notification includes information instructing the patient to access a user interface to retrieve information about the orders;
receiving input via the user interface, wherein the input indicates a status related to filling the orders; and
updating the practice management system based on the input received via the user interface, wherein the updating is performed in response to receiving the input via the user interface.

12. The computer-readable storage medium of claim 11, wherein the method further comprises:
storing, by the practice management system, a representation of the orders issued to the patient; and
wherein the updating the practice management system comprises updating the representation of the orders stored by the practice management system.

13. The computer-readable storage medium of claim 11, wherein the method further comprises:
associating an alarm with the orders issued to the patient, wherein the alarm specifies an amount of time to wait prior to sending the notification to the patient;
determining whether the amount of time specified by the alarm has passed; and
sending the notification to the patient in response to determining that the amount of time specified by the alarm has passed.

14. The computer-readable storage medium of claim 11, wherein the method further comprises:
accessing the practice management system to determine communication preferences for the patient; and
wherein the sending the notification to the patient comprises sending the notification to the patient in accordance with the determined communications preferences for the patient.

15. The computer-readable storage medium of claim 11, wherein the input received via the user interface includes scheduling information indicating when the patient has scheduled an appointment to fill the orders, and wherein the method further comprises:
associating an alarm with the orders based, at least in part, on the scheduling information.

16. The computer-readable storage medium of claim 11, wherein the method further comprises:
presenting the user interface as a web-based portal with which the patient may interact to provide the input indicating the status related to filling the orders, wherein the user interface displays a plurality of selectable options that, when selected by the patient, provide the input.

17. A practice management system configured to track patient compliance with orders issued to a patient by a medical provider, the practice management system comprising:
at least one storage medium configured to store information related to the orders; and
at least one processor programmed to:
determine based, at least in part, on the stored information related to the orders, whether a patient has filled orders;
send, in response to determining that the patient has not filled the orders, a notification to the patient, wherein the notification includes information instructing the patient to access a user interface to retrieve information about the orders;
receive input via the user interface, wherein the input indicates a status related to filling the orders; and
update the stored information related to the orders based on the input received via the user interface, wherein the updating is performed in response to receiving the input via the user interface.

18. The practice management system of claim 17 wherein the at least one processor is further programmed to:
associate an alarm with the orders issued to the patient, wherein the alarm specifies an amount of time to wait prior to sending the notification to the patient;
determine whether the amount of time specified by the alarm has passed; and
send the notification to the patient in response to determining that the amount of time specified by the alarm has passed.

19. The practice management system of claim 17, wherein the at least one processor is further programmed to:
access the practice management system to determine communication preferences for the patient; and
wherein the sending the notification to the patient comprises sending the notification to the patient in accordance with the determined communications preferences for the patient.

20. The practice management system of claim 17, wherein the input received via the user interface includes scheduling information indicating when the patient has scheduled an appointment to fill the orders, and wherein the at least one processor is further programmed to:
associate an alarm with the orders based, at least in part, on the scheduling information.

21. The practice management system of claim 17, wherein the at least one processor is further programmed to:
present the user interface as a web based-portal with which the patient may interact to provide the input indicating the status related to filling the orders, wherein the user interface displays a plurality of selectable options that, when selected by the patient, provide the input.
